(19) United States
(12) Patent Application Publication
(10) Pub. No.: US 2006/0147744 A1
(43) Pub. Date: Jul. 6, 2006

(54) Conductive metal plated polyimide substrate and process for manufacturing the same

(75) Inventors: Min Keun Seo, Yongin-City (KR); Woon Soo Kim, Yongin-City (KR); Jae Hee Kim, Suwon-City (KR)

Correspondence Address: IRVING M. WEINER;WEINER & BURT, P.C., 635 N. US-23, P.O. BOX 186, HARRISVILLE, MI, 48740, US

(73) Assignee: DMITECH CO., LTD.

(21) Appl. No.: 11/314,584

(22) Filed: Dec. 21, 2005

(30) Foreign Application Priority Data
Dec. 31, 2004 (KR) 2004-117763

(51) Int. Cl. B21D 39/00; B32B 15/06; B32B 15/08; C23C 28/00; C25D 3/00

(52) U.S. Cl. 428/624; 428/625; 428/626; 205/261; 205/188

(57) ABSTRACT

Disclosed is a process for a conductive metal plated polyimide substrate. The process for a conductive metal plated polyimide substrate comprises a) etching surface of the polyimide film with KOH, mixed solution of ethylene glycol and KOH, or mixed solution of CrO₃ and H₂SO₄, b) coupling the etched surface of the polyimide film with a coupling agent, c) absorbing a catalyst on the polyimide film, d) plating a first conductive metal on the polyimide film which the catalyst was absorbed without applying current, to form a first conductive metal thin film, and e) plating a second conductive metal on the first conductive metal thin film with applying current, to form a second conductive metal thin film.

### CROSS REFERENCE TO RELATED APPLICATION

This application claims priority to and the benefit of Korea Patent Application No. 2004-117763 filed on, Dec. 31, 2004 in the Korean Intellectual Property Office, the entire content of which is incorporated herein by reference.

### BACKGROUND OF THE INVENTION

(a) Field of the Invention

The present invention relates to a conductive metal plated polyimide substrate and a process for manufacturing the conductive metal plated polyimide substrate.

(b) Description of the Related Art

A conductive metal plated polyimide substrate is used as an important material for producing a flexible printed circuit (hereinafter, ‘FPC’). An example of the conductive metal plated polyimide substrate is a flexible copper clad laminate (hereinafter, ‘FCCL’).

Generally, polyester, polyimide, liquid crystal polymer, fluorine resin film, etc are used as an insulating film layer in FPC. Particularly the polyimide film is preferably used because of its thermal resistance, numerical stability, and good soldering.

Meanwhile, a metal material for the conductive metal includes gold and copper, etc of low electric resistance, and good conductivity. Copper is generally used in view of cost.

Meanwhile, the FCCL is essentially consisted of polyimide film layer and copper thin film layer. In view of method for laminating the polyimide film layer and the copper thin film layer, the FCCL is divided into a three layer FCCL consisting of polyimide film layer, adhesive layer, and conductive metal film layer, and a two layer FCCL consisting of polyimide film layer and conductive metal film layer.

However, the three layers FCCL have several problems, such as difficulty for forming micro circuit pattern, low flexibility, and low thermal resistance of the adhesive layer etc. Further, the adhesive layer may not be used at high temperature condition such as soldering. Thus, the two layers FCCL is preferred.

A laminating method, casting method, and plating method are known as processes for manufacturing the FCCL.

The laminating method includes spreading the adhesive on the polyimide film to form the adhesive layer, fixing the adhesive layer on the polyimide by heating the polyimide film at oven, locating the copper thin film on the adhesive layer, then pressing the resultant to produce the laminated FCCL.

The casting method includes spreading liquid phase polyimide on copper film layer, and casting the resultant to produce the laminated FCCL.

The plating method includes locating polyimide film under plating condition, forming copper layer on the polyimide film to produce the laminated FCCL.

Among these processes for manufacturing the FCCL, for the laminating method and the casting method, only few polyimide films may be used and the adhesive may cause problems. However, the plating method has advantages that commercial copper thin film is not required, and the thickness of the copper thin film may be controlled according to plating condition.

However, properties of FCCL produced by the present plating method, such as peel strength etc. are lower than those of FCCLs produced by other methods. Thus, process method for manufacturing a conductive metal plated polyimide substrate, particularly FCCL is required, which may improve properties of FCCL such as peel strength.

### SUMMARY OF THE INVENTION

In the present invention, there is provided a conductive metal plated polyimide substrate and process for manufacturing the conductive metal plated polyimide substrate. Further, there is provided a two layers FCCL by plating method, and process for manufacturing the two layers FCCL.

To solve the above problem, one aspect of the present invention provides a conductive metal plated polyimide substrate. The conductive metal plated polyimide substrate comprises a polyimide film layer, having imide ring being etched and opened on the surface of the polyimide film layer, and a conductive metal thin film layer comprising a first conductive metal thin film, and a second conductive metal thin film. The first conductive metal thin film is formed by plating a first conductive metal on the polyimide film layer according to an electroless plating method. The second conductive metal thin film is formed by plating a second conductive metal on the first conductive metal thin film according to an electro plating method.

Another aspect of the present invention provides a process for a conductive metal plated polyimide substrate. The process for a conductive metal plated polyimide substrate comprises a) etching surface of the polyimide film with KOH, mixed solution of ethylene glycol and KOH, or mixed solution of CrO₃ and H₂SO₄, b) coupling the etched surface of the polyimide film with a coupling agent, c) absorbing a catalyst on the polyimide film, d) plating a first conductive metal on the polyimide film which the catalyst was absorbed without applying current, to form a first conductive metal thin film, and e) plating a second conductive metal on the first conductive metal thin film with applying current, to form a second conductive metal thin film.

### DETAILED DESCRIPTION OF THE PREFERRED EMBODIMENTS

In the following detailed description, only the preferred embodiments of the invention have been described, simply by way of illustration of the best modes contemplated by the inventor(s) of carrying out the invention. As will be realized, the invention is capable of modification in various obvious respects, all without departing from the invention. Accordingly, the descriptions are to be regarded as illustrative in nature, and not restrictive.

A conductive metal plated polyimide substrate according to an embodiment of the present invention is achieved by plating a conductive metal on polyimide film. Thus, the conductive metal plated polyimide substrate according to the embodiment of the invention includes the conductive metal layer and the polyimide layer.

The polyimide film according to the embodiment of the present invention is not restricted, and may include a multi layered polyimide film, or a single layered polyimide film.

The present embodiment of the present invention discloses a FCCL using copper thin film as the conductive metal.

The FCCL according to the present embodiment of the present invention includes a two layers of a polyimide film and a copper plating layer. The FCCL does not include any adhesive layer.

A process for manufacturing the FCCL according to an embodiment of the present invention may includes at least several steps of degreasing step, etching step, neutralizing step, coupling step, adding catalyst step, reaction activation step, electroless plating step, and electro plating step, etc.

Hereinafter, each step of process for manufacturing the FCCL according to an embodiment of the present invention is described in detail. Further, ultrasonic wave may be radiated during at least one of steps. Ultrasonic may cause activation of reaction because the polyimide is flexible material.

1. Degreasing Step

Impurities on the surface of the polyimide film is removed through the degreasing step. The impurities includes pollutant, oil, fingerprint, etc., which came from production and handing of the polyimide film. The impurities on the surface of the polyimide film may harm peel strength of FCCL.

Ingredients of degreasing liquid for the degreasing step are not restricted in the embodiment of the present invention. Commercial alkali rinse or shampoo is used as degreasing liquid.

The degreasing step is carried during about 5 minutes at about 20° C. ° C.˜28° C. ° C. in the embodiment of the present invention.

When the degreasing step is carried at below 20° C., activity of the degreasing liquid may not be enough to achieve the purposed degreasing effect. Further, when the degreasing step is carried at more than 28° C., proper time control for the degreasing step may become difficult.

2. Etching Step

The surface of the polyimide obtained from the degreasing step is etched by using an etching solution, to reform the surface of the polyimide.

The etching solution according to the present step preferably includes KOH, mixed solution of ethylene glycol and KOH, or mixed solution of CrO₃ and H₂SO₄.

The etching step is carried during about 5˜7 minutes at 45° C.˜50° C. by immersing the polyimide film into the etching solution.

The etching step reforms the surface of the polyimide film to maximize contact between the polyimide layer and metal plated layer during the following electroless plating step. Thus peel strength of FCCL may be increased. The etching step opens imide ring of the polyimide to transform the imide ring to amide group (—CONH) or carboxyl group (—COOH). Thus the activity of polyimide film is increased.

When the etching step is carried at below 40° C., activity of the etching solution may not be enough to achieve the purposed etching effect, and partial defect may happen on the polyimide film due to long reaction time. Further, when the etching step is carried at more than 45° C., the surface of the polyimide is too rapidly etched to control uniformity and continuity on the whole surface of the polyimide film.

3. Neutralizing Step

The surface of the polyimide film obtained from the etching step is treated with acid neutralizing solution (when alkali etching solution was used) or alkali neutralizing solution (when acid etching solution was used).

K⁺ and Cr³⁺ ions remaining corresponding to the amide group or carboxyl group of the surface of the polyimide obtained from the etching step are replaced with H⁺ thorugh the present step. Thus, K⁺ and Cr³⁺ ions are removed from the surface of the polyimide film.

If these K⁺ and Cr³⁺ ions remain at the surface of the polyimide film, these K+ and Cr³⁺ ions will compete with coupling ions during the following coupling step, so that reaction between the coupling ion and the amide group or carboxyl group is interrupted.

When the neutralizing step is carried at below 10° C., activity of the neutralizing solution may not be enough to achieve the purposed neutralizing effect. Further, when the neutralizing step is carried at more than 30° C., the neutralizing reaction is too rapidly carried to control uniformity and continuity on the whole of the polyimide film.

4. Coupling Step (Adding Polarity Step)

The coupling step is carried by adding coupling agent on the polyimide film obtained from the neutralizing step.

The coupling ion is coupled with amide group or carboxyl group of the surface of the polyimide film. Thus the coupling ion adds polarity on the surface of the polyimide film. At result, the electroless plating step may be more easily carried due to polarity on the surface of the polyimide film and peel strength of FCCL is improved.

The coupling agent according to the present step includes silane coupling agent or amine coupling agent.

Commercial silane coupling agents from Shinetsu, Japan Energy or Dow corning corporation etc may be used as the silane coupling agent in the present step.

Amine coupling agents include alkali coupling agent, which is prepared by mixing NaOH with monometal amine, or acid coupling agent which is prepared by mixing ethylene diamine with HCl.

The reaction condition of the coupling step can be controlled according to property of the coupling agent used in the coupling step. For example, the coupling step is carried during about 5˜7 minutes at about 25° C.˜30° C. when silane coupling agent is used.

5. Pickling Step

The polyimide film obtained from the coupling step is immersed into acid solution at room temperature. Here, the coupling ions which are not coupled with the amide group or the carboxyl group are removed.

When the pickling step is carried for too long time, or acidity of the acid solution is too strong, the coupling ion coupled with the amide group or the carboxyl group may be removed. Thus, it is required to control reaction conditions properly not to remove the coupling ion which is coupled with the amide group or the carboxyl group.

6. Adding Catalyst Step

The polyimide film obtained from the coupling step is immersed into a catalyst solution. Here, palladium in the catalyst solution is adsorbed on the surface of the polyimide film, and the palladium is used as a catalyst.

The catalyst solution is prepared by diluting PdCl₂ and SnCl₂ with HCl in 1:1 volume ratio.

When the adding catalyst step is carried for too short time, enough palladium and tin is not adsorbed on the surface of the polyimide film so that proposed catalyst effect may not be achieved. However, when the adding catalyst step is carried for too long time, the HCl in the catalyst solution may erode the surface of the polyimide film. Thus, it is required to control reaction conditions properly.

7. Electroless Plating Step

The polyimide film obtained from the adding catalyst step is immersed into an electroless plating solution.

The electroless plating solution includes copper sulphate electroless plating solution and nickel sulphate electroless plating solution. The copper sulphate electroless plating solution is prepared from EDTA, caustic soda, formalin and copper sulphate solution. The nickel sulphate electroless plating solution is prepared from sodium hypophosphate, sodium citrate, ammonia, and nickel sulphate hexahydrate solution.

Here, the electroless plating solution may include very small amount of brightener and stabilizer etc. to improve metal property. The brightener and stabilizer may allow recycle of the electroless plating solution and storage for long time.

In the electroless plating step using the copper sulphate electroless plating solution, the electroless plating step is carried by immersing the polyimide film which catalyst was added on, into the copper sulphate electroless plating solution during about 25˜30 minutes at about 38° C.˜42° C., without applying current to the copper sulphate electroless plating solution. That is, electroless plating method forming plating film without using current is used in the exemplary embodiment of the present invention.

Here, thickness of the electroless plating film may be controlled according to plating time properly.

Meanwhile, when the electroless plating step is carried at below about 38° C., the activity of the electroless plating solution is not enough to plate on the whole of the polyimide film so that non plating area is found, partial plating is carried, and the electroless plating film is not achieved on the polyimide film. However, when the electroless plating step is carried at more than about 42° C., the plating process is too rapidly carried to achieve uniformity and adhesive property on the whole of the electroless plating film.

In the electroless plating step using the nickel sulphate electroless plating solution, the electroless plating step is carried by immersing the polyimide film into the nickel sulphate electroless plating solution during about 2 minutes at about 35° C.˜40° C.

The electroless plating step is needed to be carried for reactivity of the following plating step. The thickness of the electroless plating film is preferably about 0.1 μm to 0.2 μm. The electroless plating step is preferably carried to the degree that non plating area is not found on the surface of the polyimide film.

8. Elector Plating Step

The electrolessly plated polyimide film is immersed in an electro plating solution, and then current is allowed to the electro plating solution to carry the electro plating process.

In detail, the electrolessly plated polyimide film is immersed in the electro plating solution, and then 2 A/dm² of current is allowed to the electro plating solution during about 30 minutes during about 40° C.˜45° C. to obtain two layers FCCL, including the polyimide film and copper plated film formed on the polyimide film. During the electro plating reaction, the electro plating solution is well stirred to minimize the concentration ununiformity of the electro plating solution. These electro plating conditions can be properly controlled according to proposed thickness of copper plated film.

The electro plating solution according to the present exemplary embodiment is prepared from mixed solution of CuSO₄—H₂O, H₂SO₄ and HCl with water (ion exchanged water). The electro plating solution may further include very small amount of brightener and additives.

Further, the electro plating solution according to the present exemplary embodiment may include commercial plating solutions such as Enthone OMI, HEESUNG METAL LTD., NMP etc. The electro plating step according to the present exemplary embodiment is slowly carried for long time, at milder condition than general condition for using the commercial plating solutions.

Thus the long plating time of the present exemplary embodiment minimizes inner stress of plating film to decreases hardness, and to increase strength and softness of the plating film.

9. Physical Property Test of FCCL

To examine plating quality of the FCCL obtained according to the exemplary embodiment of the present invention, continuity of plating in the FCCL is observed with the naked eye. Θ indicates that FCCL sample is uniformly plated on the whole of the surface. ∘ indicates that FCCL sample is uniformly plated. Δ indicates that there is partially non plated area on the FCCL sample. X indicates that there is large area non plated on the FCCL sample.

The peel strength test (average value of the samples) and flexure resistance test (R=0.38 mm, 500 g, average value of the samples) are carried according to JIS-6471 standard.

Hereinafter, the invention is described in detail to the degree that an ordinary skilled person in the art may carry easily the invention in reference to following examples. However, the present invention is not restricted to the following examples.

In the example of the present invention, the polyimide sample (Aurum, Mitsui, chemistry) with width 40 mm, length 200 mm and thickness 25 μm was prepared. Then, the polyimide sample was dried during about 10 minutes at 150° C. to remove water inner the polyimide sample.

### EXAMPLE 1

The polyimide sample was immersed into 5M KOH during about 5˜7 minutes at about 45° C.˜50° C. so that the surface of the polyimide sample was etched.

The etched polyimide sample was immersed into HCl 100 ml/L during about 5˜7 minutes at room temperature, so that the surface of the polyimide sample was neutralized.

Then, silane coupling agent including aminopropyl triethoxy silane was diluted to 1.0˜1.5%/L. The neutralized polyimide sample was immersed into the diluted silane coupling agent during about 5˜7 minutes at about 25° C.˜30° C. and then the polyimide sample was dried during about 5 minutes at 110° C. Then, the polyimide sample was washed with HCl.

Then, a solution prepared from 0.5 g/L of PdCl₂ and 2 g/L of SnCl₂ was diluted with HCl in 1:1 volume ratio to obtain a catalyst solution. The polyimide sample was immersed into the catalyst solution during about 5 minutes at room temperature.

Then, copper sulphate solution (15.8 g/L) was added with a solution including EDTA solution (4.2 g/L), caustic soda solution (13.7 g/L), formalin solution (9.5 g/L) to obtain a copper sulphate electroless plating solution. The polyimide sample catalyzed was immersed into the copper sulphate electroless plating solution during 25 minutes at about 40° C. without applying current. Then the electrolessly plated polyimide sample was dried during 10 minutes at 110° C.

Then, mixed solution of CuSO₄—H₂O, H₂SO₄ and HCL was diluted with an ion exchanged water to obtain an electro plating solution. The electrolessly plated polyimide sample was immersed into the electro plating solution during 50 minutes at 40° C. and 2 A/dm² of current was applied to obtain FCCL sample.

### EXAMPLE 2

The processes described at Example 1 were carried to obtain FCCL sample except using etching solution which was prepared by mixing ethylene glycol (20 g/L) with 5M KOH solution.

### EXAMPLE 3

The processes described at Example 1 were carried to obtain FCCL except using mixed solution of CrO₃ and H₂SO₄ as an etching solution.

Physical properties of FCCLs obtained according to examples 1 to 3 were tested, and following table 1 shows the physical properties of FCCLs.

TABLE 1

| | | thickness of | | |
|---|---|---|---|---|
| | Degree | copper thin film/ | Average peel | |
| | of | thickness of | strength | Flexure |
| | plating | polyimide film (□) | (kg/cm) | resistance |
| Example 1 | Θ | 17.5/25 | 1.1 | 233 |
| Example 2 | Θ | 18/25 | 1.2 | 245 |
| Example 3 | Θ | 18/25 | 1.2 | 241 |

### EXAMPLE 4˜6

The processes described at Example 1˜3 were carried to obtain FCCL except using Nickel sulphate electroless plating solution instead of copper sulphate electroless plating solution. Thus FCCLs obtained according to the example 4˜6 have nickel electroless plating film.

The nickel sulphate electroless plating solution was prepared by mixing sodium hypophosphate (40˜50 g/L), sodium citrate (90˜160 g/L), ammonia (70˜110 ml/L), and nickel sulphate hexahydrate solution (30˜50 ml/L). The electroless plating step was carried by immersing the catalyzed polyimide sample into the nickel sulphate electroless plating solution during about 2 minutes at about 35° C.˜40° C.

The etching solution was 5M KOH in example 4. The etching solution was mixed solution of ethylene glycol and 5M KOH in example 5. The etching solution was mixed solution of CrO₃ and H₂SO₄ in example 6.

Physical properties of FCCLs obtained according to examples 4 to 6 were tested, and following table 2 shows the properties of FCCLs.

TABLE 2

| | | thickness of | | |
|---|---|---|---|---|
| | Degree | copper thin film/ | Average peel | |
| | of | thickness of | strength | Flexure |
| | plating | polyimide film (□) | (kg/cm) | resistance |
| example 4 | Θ | 17.1/25 | 1.0 | 229 |
| example 5 | Θ | 17.6/25 | 1.1 | 237 |
| example 6 | Θ | 17.7/25 | 0.9 | 208 |

### COMPARATIVE EXAMPLE 1

The processes described at Example 1 were carried except using 200 g/L of NaOH as the etching solution.

Properties of FCCL according to comparative example 1 were tested, and following table 3 shows the properties of FCCLs.

TABLE 3

| | | thickness of | | |
|---|---|---|---|---|
| | Degree | copper thin film/ | Average peel | |
| | of | thickness of | strength | Flexure |
| | plating | polyimide film (□) | (kg/cm) | resistance |
| Comparative | X | — | — | — |
| example 1 | | | | |

### COMPARATIVE EXAMPLE 2

The processes described at Example 3 were carried except using mixed solution of 12 ml/L of HF and 335 ml/L of HNO₃ as etching solution.

Physical properties of FCCL obtained according to comparative example 2 were tested, and following table 4 shows the properties of FCCLs.

TABLE 4

| | | thickness of | | |
|---|---|---|---|---|
| | Degree | copper thin film/ | Average peel | |
| | of | thickness of | strength | Flexure |
| | plating | polyimide film (□) | (kg/cm) | resistance |
| Comparative | X | — | — | — |
| example 2 | | | | |

Further, the FCCL according to comparative example 2 was produced by using mixed solution of HF and HNO₃ instead of mixed solution of CrO₃ and H₂SO₄, which was used in the example 3. The properties of the FCCL according to the comparative example 2 showed significantly poor degree of plating in comparison to the FCCL according to the example 3.

Thus comparative examples 1 and 2 shows that the etching step is significant in the process for manufacturing FCCL, and selection of etching solution are significant for property of the FCCL.

Meanwhile, a conductive metal plated polyimide substrate according to an example of the present invention includes a polyimide film layer, which imide group on surface of the polyimide film was etched and opened, a first conductive metal thin film, which was formed on the polyimide film by electroless plating method, and a second conductive metal thin film, which was formed on the first conductive metal thin film, by electro plating method.

The etched polyimide film layer is prepared by etching the polyimide film with KOH, mixed solution of ethylene glycol and KOH, or mixed solution of CrO₃ and H₂SO₄.

The first conductive metal thin film is made of gold, nickel or copper, and is formed to degree that there is no non-plated area on the whole of the polyimide film. The thickness of the first conductive metal thin film is below about 0.2 μm.

The second conductive metal thin film is made of gold or copper. The thickness of the second conductive metal thin film is preferably from about 0.5 to 30μ, and is more preferably from about 15 to 20 μm.

The conductive metal plated polyimide substrate according to the example of the present invention may be FCCLs obtained according to above examples 1˜3. The FCCLs includes a polyimide film of which surface was etched, about 0.1 μm˜0.2 μm thickness of a first copper thin film which was formed on the polyimide film according to electroless plating method, and a second copper thin film which was formed on the first copper thin film according to electro plating method. Total thickness of copper thin film including the first copper thin film and the second copper thin film is about 17 μm˜19 μm.

The FCCLs obtained according to the examples 4˜6 includes a polyimide film of which surface was etched, about 0.1 μm˜0.2 μm thickness of a nickel thin film which was formed on the polyimide film according to electroless plating method, and a copper thin film which was formed on the nickel thin film according to electro plating method. Total thickness of conductive metal thin film including the nickel thin film and the copper thin film is about 17 μm˜19 μm.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

Conductive metal plated polyimide substrate according to exemplary embodiment of the present invention shows good peel strength and flexure resistance. The thickness of metal thin film can be controlled according to plating condition.

Further, conductive metal plated polymide substrate according to exemplary embodiment of the present invention does not use any adhesive layer and thus achieve good thermal resistance, chemical resistance and flexure property.

What is claimed is:

1. A conductive metal plated polyimide substrate comprising:
a polyimide film layer, having imide ring being etched and opened on the surface of the polyimide film layer; and
a conductive metal thin film layer comprising:
a first conductive metal thin film formed by plating a first conductive metal on the polyimide film layer according to an electroless plating method; and
a second conductive metal thin film, formed by plating a second conductive metal on the first conductive metal thin film according to an electro plating method.

2. The conductive metal plated polyimide substrate of claim 1, wherein the surface of the polyimide film layer was etched using KOH, mixed solution of ethylene glycol and KOH, or mixed solution of CrO₃ and H₂SO₄.

3. The conductive metal plated polyimide substrate of claim 1, wherein the first conductive metal includes at least one selected from the group of gold, nickel, and copper on the polyimide film layer.

4. The conductive metal plated polyimide substrate of claim 1, wherein the second conductive metal includes gold or copper on the first conductive metal thin film.

5. The conductive metal plated polyimide substrate of claim wherein the first conductive metal thin film is formed on the whole of the polyimide film, and thickness of the first conductive metal thin film is below about 0.2 μm.

6. The conductive metal plated polyimide substrate of claim 1, wherein thickness of the conductive metal thin film is about 0.5 μm˜30 μm.

7. The conductive metal plated polyimide substrate of claim 6, wherein thickness of the conductive metal thin film is about 15 μm˜20 μm.

8. A process for manufacturing a conductive metal plated polyimide substrate, comprising:
a) etching surface of the polyimide film with KOH, mixed solution of ethylene glycol and KOH, or mixed solution of CrO₃ and H₂SO₄;
b) coupling the etched surface of the polyimide film with a coupling agent;
c) absorbing a catalyst on the polyimide film;
d) plating a first conductive metal on the polyimide film which the catalyst was absorbed without applying current, to form a first conductive metal thin film; and
e) plating a second conductive metal on the first conductive metal thin film with applying current, to form a second conductive metal thin film.

9. The process for manufacturing a conductive metal plated polyimide substrate of claim 8, wherein at least one step among a)˜e) are carried with radiating ultrasonic wave on the polyimide film.

10. The process for manufacturing a conductive metal plated polyimide substrate of claim 8, wherein the step a) comprises immersing the polyimide film into KOH, mixed solution of ethylene glycol and KOH, or mixed solution of CrO₃ and H₂SO₄ during about 5˜7 minutes at about 45° C.˜50° C.

11. The process for manufacturing a conductive metal plated polyimide substrate of claim 8, wherein the imide group on the surface of the polyimide film is transformed to amide group or carboxyl group during the step a).

12. The process for manufacturing a conductive metal plated polyimide substrate of claim 8, wherein the plating solution used in the step d) is
a copper sulphate plating solution being prepared from EDTA, caustic soda, formalin and copper sulphate solution; or
a nickel sulphate plating solution being prepared from sodium hypophosphate, sodium citrate, ammonia, and nickel sulphate hexahydrate solution.

13. The process for manufacturing a conductive metal plated polyimide substrate of claim 12, wherein the polyimide film is immersed into the copper sulphate plating solution during about 25˜30 minutes at about 38° C.˜42° C.

14. The process for manufacturing a conductive metal plated polyimide substrate of claim 12, wherein the polyimide film is immersed into the nickel sulphate plating solution during about 2 minutes at about 35° C.˜40° C.

15. The process for manufacturing a conductive metal plated polyimide substrate of claim 8, wherein the first conductive metal includes at least one selected from the group of gold, nickel and copper.

16. The process for manufacturing a conductive metal plated polyimide substrate of claim 8, wherein the second conductive metal includes gold or copper.

17. The process for manufacturing a conductive metal plated polyimide substrate of claim 8, wherein the first conductive metal thin film is formed on the whole of the polyimide film, and thickness of the first conductive metal thin film is below about 0.2 μm.

18. The process for manufacturing a conductive metal plated polyimide substrate of claim 8 wherein whole thickness of the first conductive metal thin film and the second conductive metal thin film is about 0.5 μm˜30 μm.

19. The process for manufacturing a conductive metal plated polyimide substrate of claim 18, wherein whole thickness of the first conductive metal thin film and the second conductive metal thin film is about 15 μm˜20 μm.
